(19) United States
(12) Patent Application Publication
(10) Pub. No.: US 2020/0009974 A1
(43) Pub. Date: Jan. 9, 2020

(54) POWER SUPPLY FOR AN AIRCRAFT AND CORRESPONDING AIRCRAFT

(71) Applicant: Dr. Ing. h.c. F. Porsche Aktiengesellschaft, Stuttgart (DE)

(72) Inventors: Stefan Bender, Löchgau (DE); Mikel Fauri, Ludwigsburg (DE)

(73) Assignee: Dr. Ing. h.c. F. Porsche Aktiengesellschaft, Stuttgart (DE)

(21) Appl. No.: 16/460,442

(22) Filed: Jul. 2, 2019

(30) Foreign Application Priority Data
Jul. 4, 2018 (DE) 102018116164.6

(51) Int. Cl. B60L 53/18; B64C 39/02; B64C 29/00; B64C 3/54; B64D 27/24; B60L 53/16

(52) U.S. Cl. CPC B60L 53/18; B64C 39/024; B64C 29/0025; B60L 2210/10; B64D 27/24; B60L 53/16; B60L 2200/10; B64C 3/546

(57) ABSTRACT

A power supply for an aircraft includes a drone capable of flight and including rotors, a DC-to-DC converter, a battery for driving the rotors and a locking device for securing a plug connection between the drone and the aircraft. The drone is set up to secure the plug connection by the locking device until the aircraft reaches a prescribed altitude, and the power supply is configured in such a way that the battery supplies power to the aircraft by the DC-to-DC converter as long as the plug connection exists.

### CROSS-REFERENCE TO RELATED APPLICATION

This application claims priority to German Patent Application No. 10 2018 116 164.6, filed Jul. 4, 2018, the content of such application being incorporated by reference herein in its entirety.

### FIELD OF THE INVENTION

The present invention relates to an aircraft, in particular a fully electric vertical take-off and landing (VTOL) aircraft. The invention also relates to a corresponding power supply.

### BACKGROUND OF THE INVENTION

VTOL is the cross-language name given in the aerospace industry to any type of aircraft, drone or rocket that has the capability of lifting off and landing again substantially vertically and without a runway. This collective term is used below in a further sense that includes not just fixed-wing aircraft with wings, but rather also rotary-wing aircraft such as helicopters, gyrocopters, gyrodynes and hybrids such as composite or combination helicopters and convertiplanes. Short take-off and landing (STOL) aircraft, short take-off and vertical landing (STOVL) aircraft and vertical take-off and horizontal landing (VTHL) aircraft are also included.

The power requirement during the take-off and landing phase of a VTOL is high. The battery of an electrically driven VTOL according to the prior art therefore has to meet extremely high requirements not only in terms of its capacity but also in terms of its power density.

WO 2010/031384 A2, which is incorporated by reference herein, discloses a method for launching a drone by means of a launching catapult, which applies the launching energy, in such a way that the launching catapult is first aligned before the launch. Here, the launching catapult is covered by means of a screen, which is removed only after the alignment and immediately before the launch. DE10 2016 219 473 A1, which is incorporated by reference herein, relates to a drone for docking onto a vehicle. In this case, the drone comprises an energy storage element and a docking device for docking the drone onto the vehicle. Furthermore, the drone comprises at least one communication unit for communication with the vehicle and/or with an external device of a user of the vehicle as well as at least one position identification unit for detecting a position of the user of the vehicle. In this case, the drone is designed, after a predeterminable trigger able to be detected by the communication unit, to identify the position of the user by way of the position identification unit, to undock from the vehicle, to return to the user of the vehicle according to the detected position and to follow said user automatically.

DE10 2007 003 458 A1, which is incorporated by reference herein, describes a device for automatically supplying energy to a small battery-operated aerial vehicle in order to ensure a virtually uninterrupted use of the aerial vehicle and to avoid constantly providing an operator. For this purpose, a landing and loading platform is provided, which is assigned a battery magazine or underneath which a charging device is provided.

### SUMMARY OF THE INVENTION

To solve the problem outlined above, an alternative energy source that does not contribute to the overall weight of the aircraft is proposed. This proposal is based on the following knowledge: the aircraft equipped with an on-board battery has a mass M_{eVTOL}+M_{Batt} and a rotor surface A_{eVTOL}. For the power P_{eVTOL/Batt} required for lift-off, the following holds true

$${P}_{eVTOL / Batt} \sim \frac{1}{{A}_{eVTOL}} \sim \sqrt{{( {M}_{eVTOL} + {M}_{Batt} )}^{3}} .$$

When the battery is removed from the aircraft, for the power P_{eVTOL} required for the lift-off thereof, the following holds true

$${P}_{eVTOL} \sim \frac{1}{{A}_{eVTOL}} \sim \sqrt{{M}_{eVTOL}^{3}} .$$

A battery with its own rotors would have a mass M_{Batt}+M_{overhead} and a rotor surface A_{Batt}. In this case, for the power required for lift-off, the following holds true

$${P}_{Batt} \sim \frac{1}{{A}_{Batt}} \sim \sqrt{{( {M}_{Batt} + {M}_{overhead} )}^{3}} .$$

When the following equation is satisfied, the power required overall for hovering is therefore reduced, with the result that an electrically driven VTOL having a coupled, autonomous flight battery would be advantageous:

$$\frac{{A}_{eVTOL} + {A}_{Batt}}{{A}_{eVTOL}} > \frac{{( {M}_{eVTOL} + {M}_{Batt} + {M}_{overhead} )}^{3}}{{( {M}_{eVTOL} + {M}_{Batt} )}^{3}}$$

In view of the foregoing, described herein is an aircraft, in particular a fully electric vertical take-off and landing aircraft in the above sense, and a power supply for such an aircraft according to the independent claims.

Further advantageous configurations of the invention are specified in the dependent patent claims. The aircraft may thus be equipped for instance with bent or even selectively bendable wings. A corresponding variant increases the effective wing surface in horizontal flight, without however increasing the footprint of the aircraft.

The aircraft may furthermore have a fast-charging battery system that provides the drive energy for vertical take-off and landing and horizontal flight and allows quick charging of the aircraft when stationary.

In this case, instead of free-moving rotors, a plurality of ducted fans, including of different sizes, may be used to drive the aircraft, as are known outside of the aerospace industry, for instance for hovercraft or fanboats. The cylindrical housing surrounding the fan may considerably reduce thrust losses caused by vortexes at the blade tips in such an embodiment. Suitable ducted fans may be aligned horizontally or vertically, designed so as to pivot between both positions or be covered by louvers during horizontal flight for aerodynamic reasons. Pure horizontal thrust generation using fixed ducted fans is additionally conceivable.

Finally, in addition to preferably fully autonomous operation of the aircraft, it is also possible to consider granting manual control to human pilots if they are sufficiently qualified, which gives the device according to aspects of the invention the greatest possible flexibility in terms of handling.

### BRIEF DESCRIPTION OF THE DRAWING

One exemplary embodiment of the invention is illustrated in the drawings and will be described in more detail below.

FIG. 1A shows the lift-off of an aircraft according to aspects of the invention.

FIG. 1B shows the aircraft before its transition to cruising flight.

FIG. 2 depicts an isometric view of an aircraft, wherein the wings are shown in an extended configuration and the rear propellers are shown in an angled orientation.

FIG. 3 depicts a front elevation view of the aircraft of FIG. 2, wherein the wings are shown extended configuration and the rear propellers are shown in a cruising orientation.

FIG. 4 depicts another front elevation view of the aircraft, wherein the wings are shown in a folded configuration and the rear propellers are shown in a take-off/landing orientation.

FIG. 5 depicts a top plan view of a portion of an aircraft, showing an internal duct extending between a nose of the aircraft and a horizontal fan mounted to the wing.

FIG. 6 depicts moveable louvers applied on top of the horizontal fan of FIG. 5, wherein the louvers are shown in a closed position.

FIG. 7 depicts the movable louvers of FIG. 6, wherein the louvers are shown in an open position.

### DETAILED DESCRIPTION OF THE INVENTION

The terms ‘fan,’ ‘rotor’ and ‘propeller’ may be used interchangeably herein.

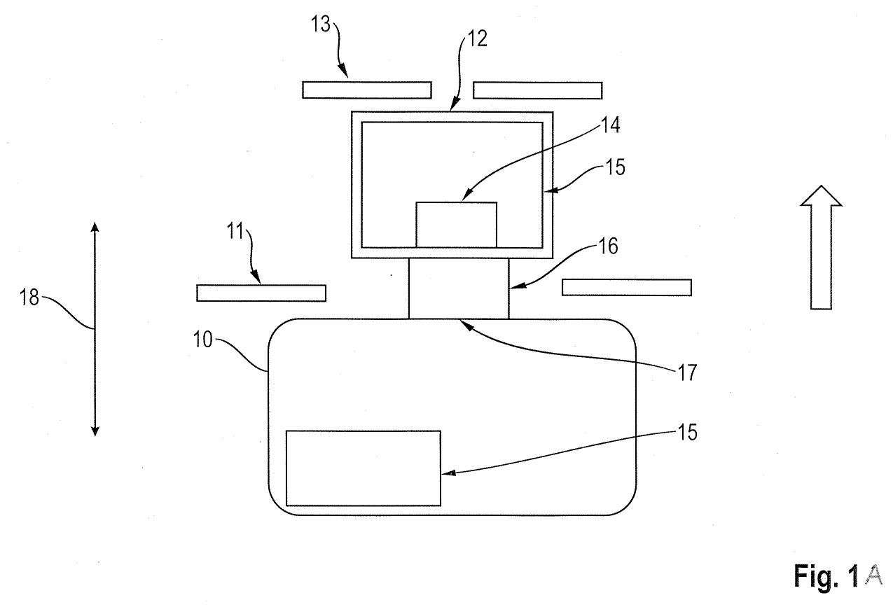

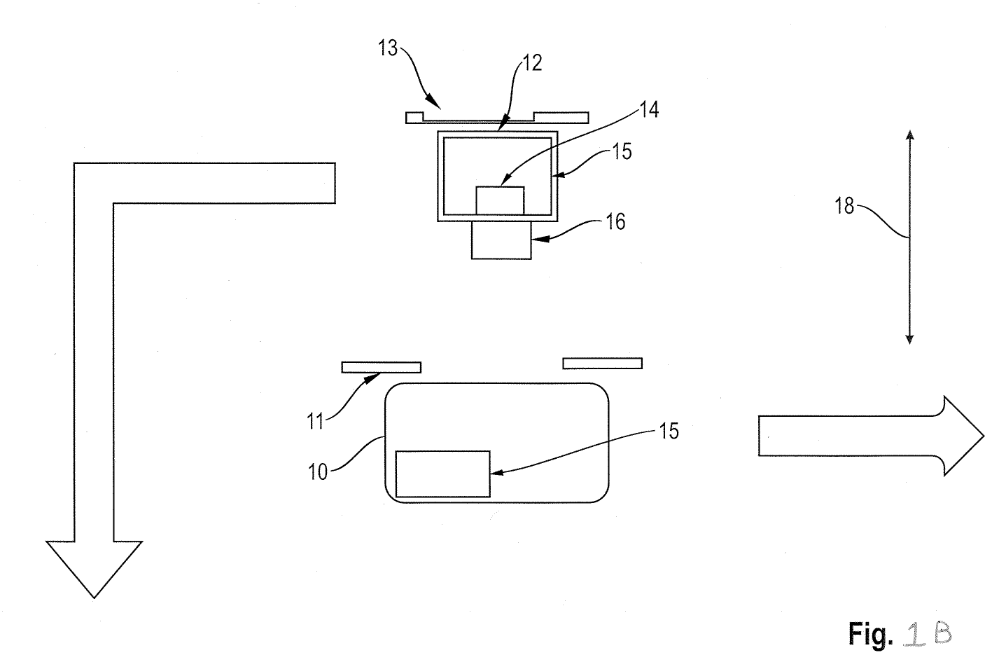

FIGS. 1A and 1B, when considered together, illustrate the design features and functional features of a preferred embodiment of the aircraft 10 according to aspects of the invention.

During the launch illustrated in FIG. 1A, the rotor systems 11, 13 that are coordinated with one another by means of a communication connection 18 between the aircraft 10 and the drone 12 lift off together. A locking device 17 secures a plug connection 16 between the drone 12 and the aircraft 10.

In this case, the aircraft 10 is the master and the drone 12 equipped with its own battery 15 is the slave. Both batteries 15 are connected to one another and supply power to both the aircraft 10 and the rotors 13 of the drone 12. A DC-to-DC converter 14 on board the drone 12 ensures that the voltages match and controls the flow of energy.

When the transition altitude is reached, the autonomous battery drone 12 is released and flies back to the ground. The aircraft 10 then continues the flight exclusively using its own on-board battery 15.

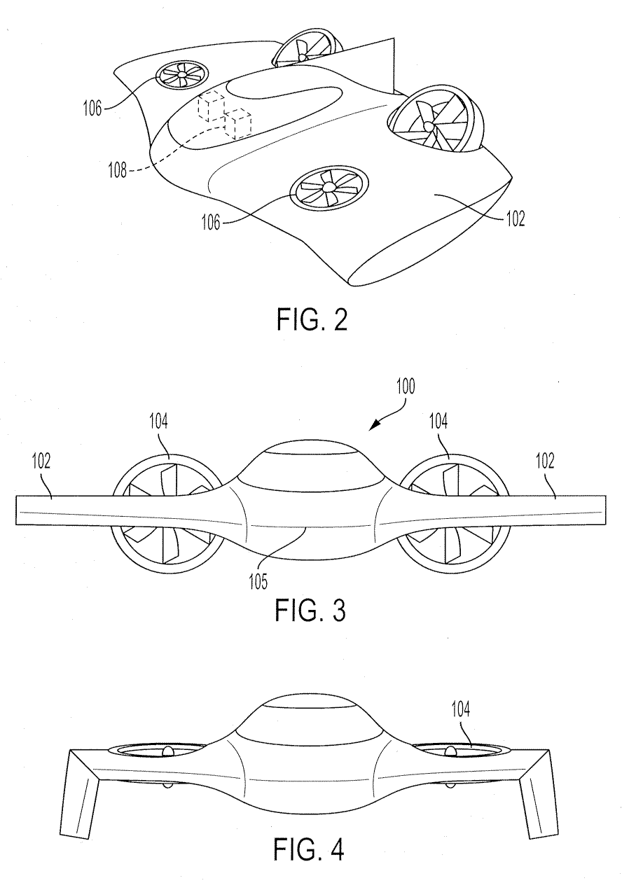

FIGS. 2-4 depict an aircraft 100. The aircraft 100 shown in those figures may appear different from the previously described aircraft 10, however, most (if not all) of the details of the previously described aircraft 10 also apply to aircraft 100.

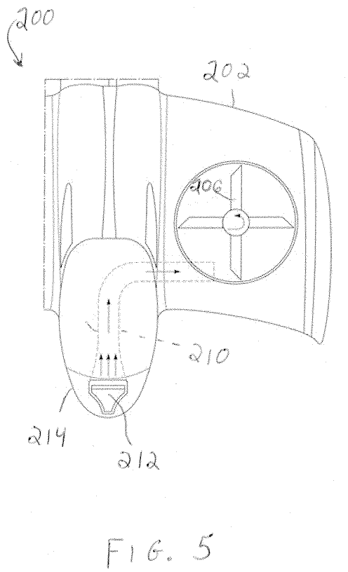

The aircraft 100 includes foldable wings 102. The wings 102 are shown in a folded configuration in FIG. 4 and an extended configuration in FIG. 3. A motor or solenoid is configured to move the wings between those configurations.

Rear propellers 104 are mounted on the trailing edge of the airfoils or wings 102 (i.e., the edge furthest from the nose 105). Propellers 104 may be referred to as cruising propellers because they are used during the cruising operation of the aircraft (at least in one position of the propellers 104). The propellers 104 are configured to pivot between two different positions, as shown in FIGS. 2-4. In the vertical position of the propellers 104 shown in FIG. 3, the propellers 104 generate maximum horizontal thrust for cruising operation of the aircraft (i.e., while the aircraft is flying through the air). In the horizontal position of the propellers 104 shown in FIG. 4, the propellers 104 generate maximum vertical thrust for take-off and landing operations of the aircraft. A motor or solenoid is configured to move the propellers 104 between those two positions. Alternatively, the propellers 104 may be immovable and fixed in a vertical position, as shown in FIG. 2.

Horizontally mounted propellers 106 are fixedly mounted and integrated into the wings 102. Unlike the propellers 104, the position of the propellers 106 is fixed, however, those skilled in the art will recognize that the propellers 106 could be modified so that they are pivotable between vertical and horizontal positions. The propellers 106 generate maximum vertical thrust for take-off and landing operations of the aircraft. The propellers 106 may also be referred to herein as lifting propellers.

The propellers 104 and 106, which may also be referred to herein as fans, may be operated by a fully-electric drive. To that end, a battery charging system 108 including a charger, an inverter and a fast-charging battery are positioned within the fuselage of the aircraft for powering the propellers 104 and 106. The fuselage may also be configured to carry one or more passengers.

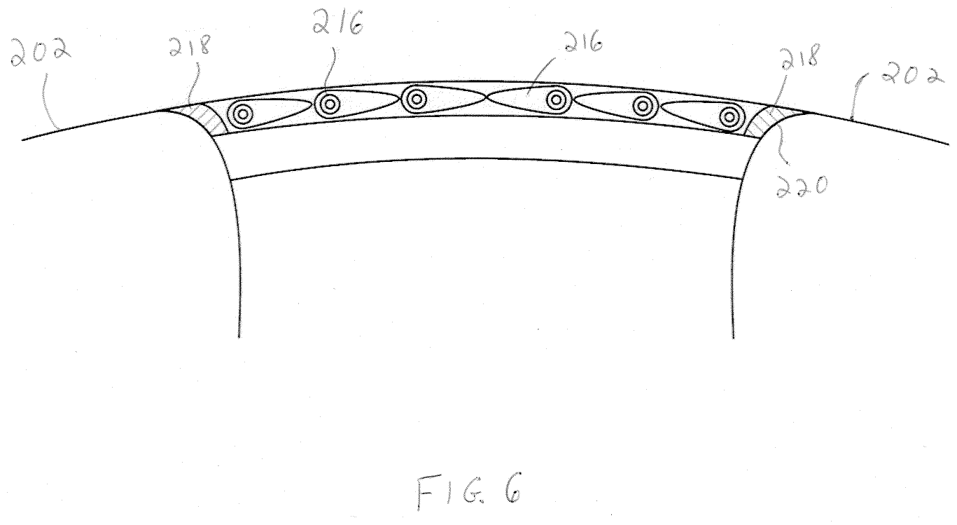

FIGS. 5-7 depict views of an aircraft 200. The aircraft 200 shown in those figures may appear different from the previously described aircraft 100, however, most (if not all) of the details of the previously described aircraft 100 also apply to aircraft 200. Only a segment of the aircraft 200 is shown in FIG. 5. An air duct 210 extends between an opening 212 formed on the nose 214 of the aircraft 200 and the horizontally mounted propeller 206 that is fixedly mounted to the wing 202. In operation, air is delivered to the propeller 206 via the duct 210, as depicts by the arrows. Although not shown, air ducts that are similar to duct 210, may extend to the propeller 206 on the opposite wing 202, as well as any rear propellers 104 (not shown in these views). Accordingly, the propellers may be referred to as either “ducted propellers” or “ducted fans.”

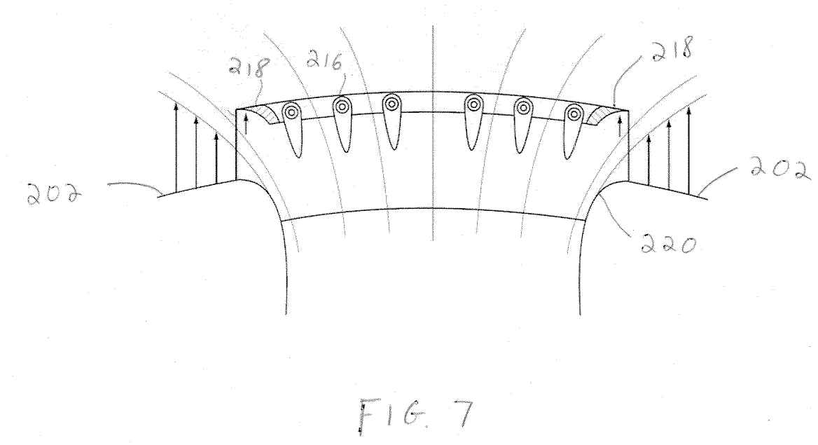

FIGS. 6 and 7 depict louvers 216 that are configured to selectively cover the horizontally mounted propellers 206. It is noted that the louvers 216 are omitted from FIG. 5 for clarity purposes. Each louver 216 is rotatable about a shaft (or otherwise moveable) between a closed position (FIG. 6) and an open position (FIG. 7). The louvers 216, which are flush with the top face of the wing 202, may be moved to the closed position during the cruising operation of the aircraft 200 for aerodynamic purposes. The louvers 216 may be moved to an open position at any time during operation of the propellers 206 to permit the exit or entrance of air therethrough. A motor or solenoid is configured to move the louvers 216 between those positions. It is noted that the louvers are shown in a closed position in FIG. 2.

A sealing ring 218 surrounds the louvers 216 and is moveable between a retracted position (FIG. 6) and a deployed position (FIG. 7). The louvers 216 are mounted to the sealing ring 218 and move therewith between the retracted and deployed positions. The lower surface of the sealing ring 218 is configured to be in sealing relationship with an opening 220 formed in the wing 202. It should be understood that the opening 220 accommodates the body of the propeller 206. The sealing ring 218 may be moved to the retracted position, which is flush with the top face of the wing 202, during cruising operation of the aircraft 200 for aerodynamic purposes. Alternatively, the sealing ring 218 may be moved to the deployed (i.e., extended) position at any time during operation of the propellers 206 to permit the exit or entrance of air, as depicted by the arrows in FIG. 7. A motor or solenoid is configured to move the sealing ring 218 between those positions.

What is claimed is:

1. A power supply for an aircraft, comprising:
a drone configured for flight, said drone comprising rotors, a DC-to-DC converter, a battery for driving the rotors and a locking device for securing a plug connection between the drone and the aircraft, wherein the drone is configured to secure the plug connection by means of the locking device until the aircraft reaches a prescribed altitude; and
wherein the power supply is configured in such a way that the battery supplies power to the aircraft by means of the DC-to-DC converter as long as the plug connection exists.

2. The power supply as claimed in claim 1, wherein the drone is further configured to automatically return to ground level after the prescribed altitude has been reached.

3. The power supply as claimed in claim 1, wherein the drone is further configured to enter into a communication connection with the aircraft in order to adjust a common flight behavior.

4. The power supply of claim 1 further comprising the aircraft, wherein the aircraft comprises the power supply and a fully electric drive.

5. The aircraft as claimed in claim 4, wherein the aircraft comprises bent or bendable wings.

6. The aircraft as claimed in claim 4, wherein the aircraft comprises a fast-charging battery system.

7. The aircraft as claimed in claim 4, wherein the aircraft comprises horizontally fixed ducted fans for take-off and landing.

8. The aircraft as claimed in claim 7, wherein the aircraft has louvers, and the horizontal ducted fans are configured to be selectively covered by the louvers.

9. The aircraft as claimed in claim 4, wherein the aircraft comprises vertically fixed ducted fans for generating a propulsion.

10. The aircraft as claimed in claim 4, wherein the aircraft is configured to be selectively controlled in a fully autonomous manner.
